(19) United States
(12) Patent Application Publication
(10) Pub. No.: US 2016/0208746 A1
(43) Pub. Date: Jul. 21, 2016

(54) HEAT EXCHANGER

(71) Applicant: MAHLE BEHR GMBH & CO. KG, Stuttgart (DE)

(72) Inventor: Peter Geskes, Ostfildern (DE)

(73) Assignee: Mahle Behr GmbH & Co. KG, Stuttgart (DE)

(21) Appl. No.: 14/912,919

(22) PCT Filed: Aug. 8, 2014
(86) PCT No.: PCT/EP2014/067103

§ 371 Date: Feb. 18, 2016

(30) Foreign Application Priority Data
Aug. 19, 2013 (DE) 10 2013 216 408.4

(51) Int. Cl. F02M 26/32; F28F 1/04; F28F 3/04; F28F 1/42; F28F 3/02; F28F 9/02

(52) U.S. Cl. CPC F02M 26/32; F28F 3/025; F28F 9/0282; F28F 3/044; F28F 3/046; F28F 1/422; F28F 1/04

(57) ABSTRACT

A heat exchanger for an exhaust gas cooler may include a substantially fluid-tight housing for conducting a first mass flow. At least one heat-permeable tube may extend in the housing for conducting a second mass flow. The housing and an outer surface of the at least one tube may define at least two parallel flow paths for the first mass flow. A plate at least partially containing the at least one tube may delimit the at least two flow paths on a face end. A connection may be arranged in a region of the plate for introducing the first mass flow into the housing. The outer surface of the at least one tube may have an elevation configured to distribute the first mass flow substantially uniformly after entering the housing and divide the first mass flow substantially uniformly among the at least two flow paths.

### CROSS-REFERENCE TO RELATED APPLICATIONS

This application claims priority to German Patent Application No. 10 2013 216 408.4, filed Aug. 19, 2013, and International Patent Application No. PCT/EP2014/067103, filed Aug. 8, 2014, both of which are hereby incorporated by reference in their entirety.

### TECHNICAL FIELD

The invention relates to a heat exchanger. It further relates to an exhaust gas cooler having a heat exchanger of this kind.

### BACKGROUND

In modern internal combustion engines part of the combustion exhaust gas is increasingly diverted in the exhaust manifold, mixed with aspirated fresh air as ballast gas and fed back into the combustion chamber, in order to increase the thermal capacity of the combustion mixture and thereby lower the combustion temperature. In order to reduce nitrogen oxide and particulate emissions, so-called exhaust gas coolers are used in this context, which are thermally loaded to a high degree by the combustion exhaust gases introduced. Said combustion exhaust gases may exhibit temperatures of up to 700° C. when the internal combustion engine is running

Traditional exhaust gas coolers usually satisfy the operating principle of a heat exchanger which transfers the heat removed from the combustion exhaust gas from the combustion chamber to a coolant. Since the mass flows as such remain separated by a heat-permeable wall in the exhaust gas cooler, corresponding devices are classified among experts as indirect heat exchangers, recuperators or heat exchangers. The extent of the heat transfer, frequently characterized within the automobile industry by the characteristic variable Q100, is heavily dependent on the relative geometric guidance of the exhaust gas and coolant flow in this case.

DE 10 2008 045 845 A1, for example, is based on a flow-conducting element for configuration in a heat exchanger to a fluid flow conduction influencing the heat exchange along a main longitudinal flow direction from a fluid inlet to a fluid outlet. According to this design, the flow-conducting element has a planar datum plane extending in the main longitudinal flow direction, wherein at least partially lateral delimiting structures for the formation of at least one flow path rise above the datum plane. To influence the flow conduction in the main longitudinal flow direction, the at least one flow path has a first upstream interval of the lateral delimiting structures and a second downstream interval of the lateral delimiting structures, wherein the intervals differ in such a manner that a fluid pressure loss attributed to the flow path from a point attributed to the first upstream interval to a point attributed to the second downstream interval is different to a pressure loss in an imaginary flow path with substantially identically spaced delimiting structures.

When using heat exchangers in the context of exhaust gas cooling in a motor vehicle, the coolant mass flow conveyed by a cooling water pump may often be insufficient or the geometry of the heat exchanger may not be optimal, so that local hotspots can occur in the heat exchanger due to areas in which the through-flow is inadequate.

### SUMMARY

The problem addressed by the invention is therefore that of providing an improved heat exchanger which—particularly in the context of exhaust gas cooling—reliably prevents the occurrence of so-called hotspots. A further problem addressed by the invention involves the creation of a corresponding exhaust gas cooler.

These problems are solved by a heat exchanger and by an exhaust gas cooler, as disclosed herein.

The invention therefore rests on the basic principle of a tubular heat exchanger (THE), through the so-called tubular space whereof a second mass flow, for example exhaust gas in an internal combustion engine, is pumped or otherwise conveyed. The at least one tube creating the tube space in this case runs in a so-called shell space delimited by a fluid-tight housing, which shell space is flowed through by a first mass flow, coolant for example, and is provided with elevations on its outer surface according to the invention, which elevations to a small extent retain the first mass flow, so the coolant for example, flowing around the tube(s), and thereby direct it. Of course in this case, from a purely theoretical standpoint, it may also only be a single tube that is present, although reference is always made to “tubes” below, whereas this may similarly also apply to an embodiment with only one tube. The housing and the outer surfaces of the at least one tube form parallel flow paths for the first mass flow which are delimited on the face end by a plate in which the at least one tube is contained. The first mass flow is introduced into the housing via a connection in the region of the plate, preferably at right angles to the second mass flow. The elevations on the outer surfaces of the tubes in this case are configured in such a manner that the first mass flow is distributed substantially uniformly in the region of the plate after entering the housing and is divided substantially uniformly among the flow paths.

The elevations on the outer surfaces of the tubes at least slightly retain the first mass flow in many regions and thereby direct it to other regions which have a poorer through-flow and are at risk of boiling or else increase the volume flow there. Particularly when using the heat exchanger in an exhaust gas cooler in which the first mass flow is introduced into the housing laterally and substantially diverted through the forming thereof, for example at right angles, this modification of the heat exchanger has proved advantageous. To this extent, the elevations of the tube surfaces described reduce the risk of so-called dead spaces or hotspots forming within the exhaust gas cooler, which only have an inadequate through-flow and are therefore exposed to a particularly intensive thermal load. Particularly in modern motor vehicles in which the coolant circuit is often only operated at a small flow rate for the purposes of energy conservation, the configuration of the heat exchanger according to the invention thereby helps to reduce substantially the risk of overheating phenomena such as local coolant boiling episodes with the resulting detrimental chemical reactions and, in this way, to increase the overall service life of the exhaust gas cooler considerably.

In a preferred embodiment, the aforementioned elevations in this case are configured by means of suitable forming technology in sheet metal, for example thin sheet metal, enclosing the outer surface. By way of an economical method, this approach allows the selective plastic forming of a tube according to the invention based on a customary semi-finished product or rolled finished product, without the dimensions and coherence thereof being substantially affected. At the same time, depending on the grade of steel involved and the operating point sought, the tubes may be tin-plated, galvanized, copper-plated, nickel-plated, painted, enameled or plastic-coated, for example, and also connected by means of known joining techniques such as welding, soldering, riveting, folding and creasing, screwing, bonding or clinching.

An established pressure-forming method, in particular the stamping of the elevation in a planar region of the outer surface, is particularly recommended in this respect from a process point of view. A suitable forming tool, such as embossing machines or presses, will be known to the person skilled in the art and will have been tried and tested in terms of practical production aspects.

With regard to the shape of the elevations, there is a plurality of possible variants in this case, ranging from a simple stud on the outer surface to the embossing of the elevation through a bead on the opposite inner surface of the sheet metal. The availability of a huge variety of bead rollers means that the latter option opens up a wide selection of different forming alternatives and setting angles to the person skilled in the art. With a professional design, the execution of the elevations as beads not only helps, in addition, to reduce any stress peaks in the sheet metal of the tubes caused by the embossing process, but also, advantageously, to strengthen the entire heat exchanger.

In order to increase the size of the outer surface still further and thereby further improve the heat exchange, the tubes are preferably provided with winglets which can increase the turbulence in the first and/or second mass flow substantially. A comparable maximization of the contact surface can be achieved by means of corrugations similarly formed in the sheet metal, cooling corrugations for example, which at the cost of a slight weight increase simultaneously increase the mechanical strength of the heat exchanger and reduce the sound radiation of a corresponding exhaust gas cooler by suppressing surface vibrations.

In an advantageous embodiment, the tubes may be connected in a substance-bonded fashion to the plate of the housing, so that the resulting atomic or molecular forces support the structural cohesion of the heat exchanger. Apart from with the use of one of the numerous welding methods known in the art, this kind of substance bonding can also be achieved by soldering, without having to exceed the liquid temperature of the tube or plate—taking into account the known detrimental consequences for the base materials in each case.

Finally, it may prove pragmatic in the context of exhaust gas cooling for the tubular heat exchanger according to the invention to be equipped with a diffusor oriented at right angles to the connection to introduce the combustion exhaust gases to be cooled. In this way, not only is the gas pressure in the exhaust gas line set at a desired pressure level but, in addition, in a reversal of the working principle of a nozzle, the mass flow conducted through the line is slowed down on entering the heat exchanger and the through-flow cross section thereof is increased overall for the exhaust gas, which has a positive effect on the transmission capacity.

Further important features and advantages of the invention result from the dependent claims, drawings and associated description of the figures with the help of the drawings.

It is clear that the aforementioned features and those yet to be explained below can not only be used in the combination indicated in each case, but also in other combinations or alone, without leaving the framework of the present invention.

Preferred exemplary embodiments of the invention are shown in the drawings and explained in greater detail in the description below, wherein the same reference numbers relate to the same or similar or functionally identical components.

### BRIEF DESCRIPTION OF DRAWINGS

The figures each show schematically

FIG. 1 a sectional perspective view of a first embodiment of the tube of a heat exchanger according to the invention,

FIG. 2 a sectional perspective view of a second embodiment of the tube of a heat exchanger according to the invention,

FIG. 3 a cross section of the corresponding tube of a third embodiment,

FIG. 4 a cross section of the corresponding tube of a fourth embodiment,

FIG. 5 the cross section of a fifth embodiment of a heat exchanger according to the invention, and

FIG. 6 the sectional longitudinal section of an exhaust gas cooler according to the invention.

### DETAILED DESCRIPTION

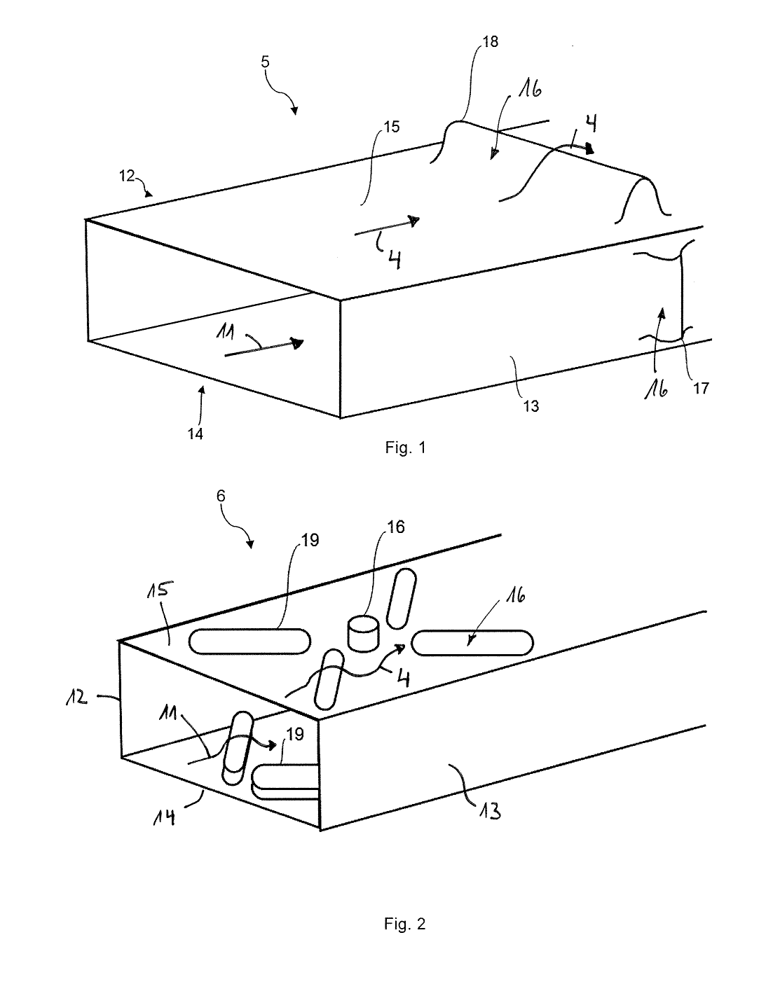

FIG. 1 illustrates the specific nature of a tube 5 of a heat exchanger 1 according to the invention (cf. FIG. 6). In the present context, any substantially fluid-tight hollow body of which the length is substantially greater than the diameter and which, in contrast to a hose, for example, is produced from a comparatively inflexible material can be regarded as a tube 5-10.

The tube 5 in FIG. 1 specifically has a rectangular cross section and therefore an approximately box-shaped form overall. A design of this kind is sometimes referred to as an oblong and is formed in the present case by two narrow outer surfaces 12, 13 and also two wide outer surfaces 14, 15 formed from sheet metal, which constitute the side walls of the tube 5. The narrow outer surfaces 12, 13 in this case are each provided with a convex elevation 16 running at right angles to their longitudinal axis in the form of a short transverse bead 17 in the corresponding counter-surface, while the wide outer surfaces 14, 15 exhibit elevations 16 which are embossed in a similar manner with long transverse beads 18. In this case, technical limitations of the forming method applied during production mean that at least the elevations 16/beads 17, 18 that can be seen from the perspective in FIG. 1 do not extend over the entire width of the outer surfaces 13, 15 in each case, but end just short of the edges on either side. The beads 17, 18 described can be seen on the outer surface 12, 13, 14, 15 as a negative bead 17, 18, so as an embossment. Flow paths 24 are arranged in this case between the tubes 5-10 or between a tube 5-10 and the housing 3, which flow paths are linked up to one another at least partially and/or are connected to one another in a communicating manner, but run substantially in parallel.

Meanwhile, the alternative embodiment in FIG. 2 is characterized by an elevation 16, 19 which is not configured in a groove shape like the beads 17, 18, but like a protuberance, in the form of a virtually circular stud 16. In addition, the corresponding tube 6 in FIG. 2 has so-called winglets 19 radiating in a star shape from the stud 16, which winglets increase the wide outer surfaces 14, 15 of the tube 6 and have a tendency to promote turbulence in the mass flow 11, 4 conducted therein or thereabout.

The tube 8 depicted in cross section in FIG. 4 is also provided with further geometric improvements in the form of corrugations 20, in addition to the beads 17, 18.

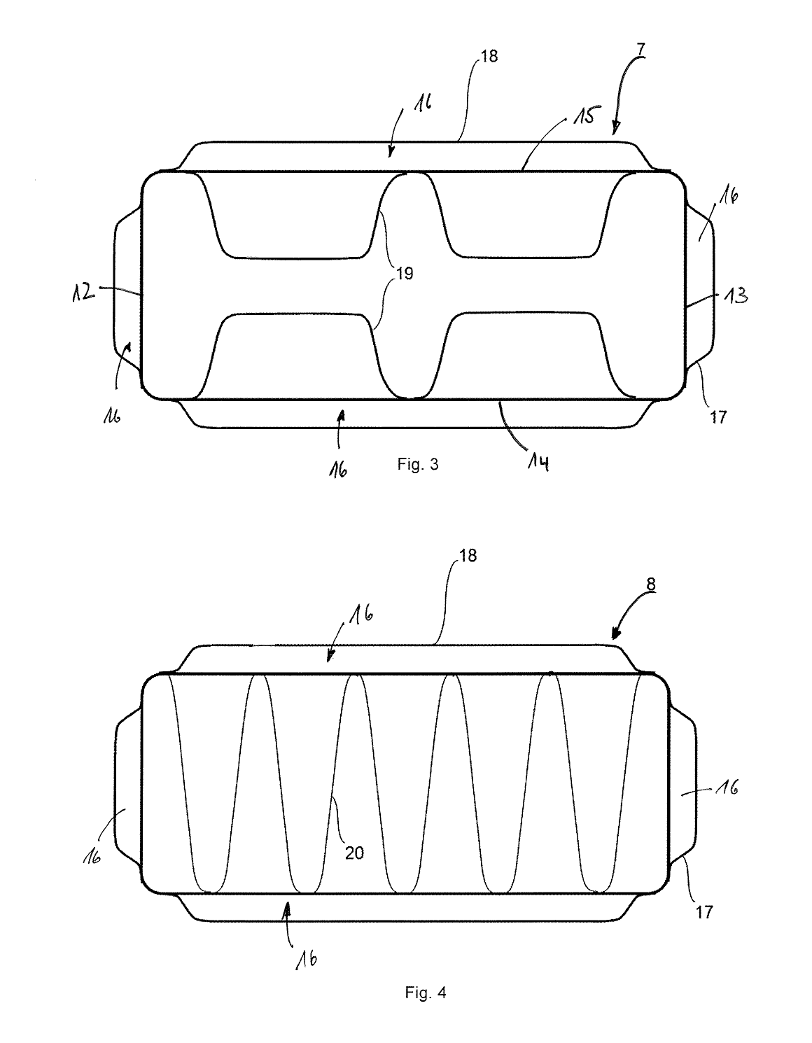

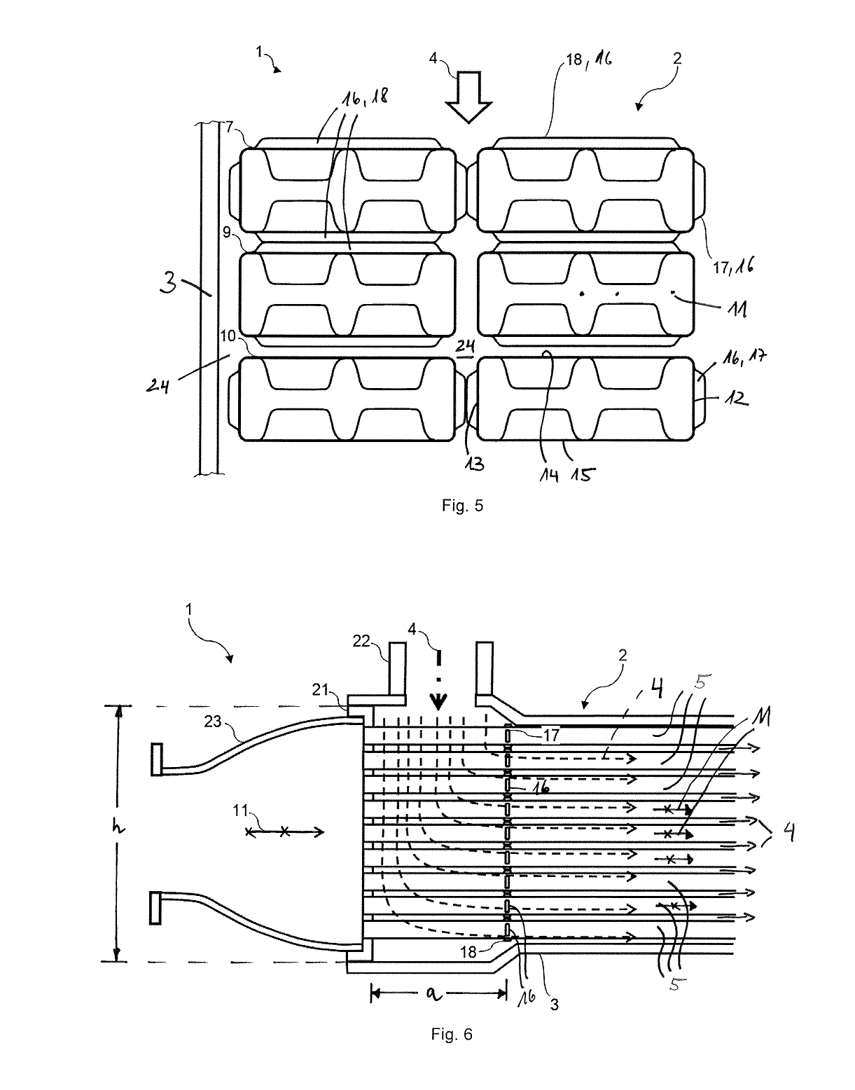

The more comprehensive cross section of a heat exchanger 1 used in the context of an exhaust gas cooler 2 according to FIG. 5 illustrates a plurality of tubes 7, 9, 10 with a height of 4 to 5 mm running in two layers in a substantially axis-parallel fashion, which tubes offer an intermediate space of 2 mm for a first mass flow 4 along their outer surfaces through their relative configuration in pairs. Characteristic of this exemplary embodiment is the specific sequence of the differently configured tubes 7, 9, 10 in the direction of the first mass flow 4, which is characterized by a decreasing number of elevations 16/beads 17, 18 in the successive tubes 7, 9, 10. Hence, the tubes 7 corresponding to the embodiment according to FIG. 3 have short stamped elevations 16/(transverse) beads 17 according to the invention on their narrow outer surfaces 12, 13 in addition to traditional winglets 19, as well as long elevations 16/(transverse) beads 18 on their wide outer surfaces 14, 15 which each have a height of roughly 1 mm. Meanwhile, the tubes 9 following downstream have no laterally formed, short elevations 16/transverse beads 17 on the tubes 7. The tubes 10 through which the mass flow 4 passes last finally have only short elevations 16/transverse beads 17 on their narrow outer surfaces 12, 13, while the wide outer surfaces 14, 15 are only enlarged by winglets 19.

The longitudinal section in FIG. 6 illustrates the benefit of a heat exchanger 1 according to the invention within the framework of an exhaust gas cooler 2 which is in fluidic connection via a lateral connection 22 with a coolant circuit and via a diffusor 23 arranged on the face end with an exhaust gas line. In this case, the second mass flow 11 formed by the combustion exhaust gas of an internal combustion engine not shown in FIG. 6 enters substantially via the entire width of the housing 3 into the tubes 5 inserted in the plate 21 thereof, which tubes correspond to the embodiment in FIG. 1. The lateral attachment of the connection 22 causes, by comparison, a virtually orthogonal entry of the first mass flow 4 created by a suitable coolant into the shell space of the heat exchanger 1 delimited by the housing 3, which, however, is not substantially delayed by the short and long elevations 16/transverse beads 17, 18 formed in the tubes 5 downstream of the connection 22. The negligible accumulation of coolant within the entry region of the housing 3 which results guarantees a largely homogenous volume flow over the entire width thereof along the outer surfaces 12, 13, 14, 15 of the tubes 5, so that a hotspot can be avoided in the housing 3, particularly in the regions facing away from the connection 22, in particular in a dead space occurring there in the case of traditional heat exchangers. The number of elevations 16/beads 17, 18 in the tubes 5 decreases in this case from top to bottom, as a result of which any blocking of the flow paths 24 is increasingly reduced. The elevations 16/beads 17, 18 of adjacent tubes 5 which are mutually in contact with one another may, for their part, be permanently connected, in order to increase the rigidity of the exhaust gas cooler 2.

A ratio a/h between an interval a between the plate 21 and the elevation 16/bead 17, 18 and the height h of the plate 21 is around 0.3<a/h<0.7, preferably around 0.4<a/h<0.6. In this way, a particularly uniform temperature distribution can be achieved.

The interval a between the plate 21 and the elevation 16/bead 17, 18 is approx. 20 to 60 mm, preferably 30 to 60 mm. This guarantees an optimum retention effect of the first mass flow 4, for example of the coolant, and therefore a particularly uniform distribution of the same in the region of the plate 21, as a result of which so-called hotspots in particular, where there has to be a risk of the first mass flow 4 boiling, can be avoided. In this case, the closer the elevations/beads 16, 17, 18 are arranged to the lateral end of the connection 22, the smaller the interval a from the plate 21 is and the more effective the deflection of the first mass flow 4 and therefore the cooling. In this region upstream of the elevations/beads 16, 17, 18 a flow field should be produced within which the temperature is as uniform as possible, said temperature being below the boiling temperature of the coolant 4, as a result of which local boiling of the same with the associated problems can be avoided.

As a general rule, the elevations 16/beads 17, 18 at individual points or at a plurality of points are arranged in the peripheral direction of the tube 5-10. Moreover, the elevations 16/beads 17, 18 need not pass over the entire tube width, but may also extend over only a section of the tube width. The beads 17, 18 or elevations 16 in this case never block the flow paths 24 entirely; part of the first mass flow 4 can therefore also still run along the tubes 5-10, despite the elevations 16/beads 17, 18.

In order to be able to achieve the most uniform through-flow possible and therefore also a uniform temperature throughout the region of the points at risk from boiling, a porosity factor F, in other words a throughput factor, of 60% and 90% (ideal pressure drop) through the elevations/beads 16, 17, 18 is sought, wherein the porosity factor F is defined as follows:

F=(A_KM1−A_KM2)/A_KM2

where:
A_KM1: is the surface on the coolant side which is to be assigned to one of the tubes with elevations/beads (as a partial surface of the total cross-sectional surface)
A_KM2: is the surface on the coolant side which is to be assigned to one of the tubes but is blocked by elevations/beads,
(A_KM1−A_KM2) is the remaining open surface through which coolant (C) can continue to flow.

The porosity factor F should fall within the region of 20% in the case of tubes 5 more remote from the hotspots, through F approx. 80% for the tubes 5 located closer to the hotspots, up to F=100% for the tubes 5 lying directly adjacent to the hotspots, wherein 100% signifies complete permeability without elevations 16/beads 17, 18.

The porosity factor F therefore drops in the heat exchanger 1 for tubes 5-10 starting from the connection 22 from top to bottom. The porosity factor F (opening degree) therefore increases, the closer the respective tube 5-10 or the respective row of tubes is to the hotspots. Ideally, the value should be between 60% and 90%, as the pressure drop does not then rise too sharply.

In an alternative embodiment of the invention, the tubes 5-10 may have along their longitudinal axis a plurality of elevations/beads 16, 17, 18 at specific intervals or characteristic combinations of elevations/beads 16, 17, 18 running transversely and longitudinally. In this case, the elevations/beads 16, 17, 18 may also be provided on only one side of each tube 5-10 in each case, although in return they will be twice as high compared with the two-sided configuration.

1. A heat exchanger for an exhaust gas cooler, comprising:
a substantially fluid-tight housing for conducting a first mass flow,
at least one heat-permeable tube extending in the housing for conducting a second mass flow,
wherein the housing and an outer surface of the at least one tube define at least two parallel flow paths for the first mass flow, and wherein the at least two flow paths are delimited on a face end by a plate, the plate containing at least partially the at least one tube,
a connection arranged in a region of the plate configured to introduce the first mass flow into the housing,
wherein the outer surface of the at least one tube includes an elevation configured to distribute the first mass flow substantially uniformly in the region of the plate after entering the housing and divide the first mass flow substantially uniformly among the at least two flow paths.

2. The heat exchanger as claimed in claim 1, wherein the at least one tube is configured as a sheet metal part and the elevation is defined on the outer surface of the sheet metal part.

3. The heat exchanger as claimed in claim 1, wherein the elevation is a stud.

4. The heat exchanger as claimed in claim 1, wherein the at least one tube has an inner surface including a bead disposed opposite of the elevation on the outer surface, and wherein the bead on the inner surface embosses the elevation on the outer surface.

5. The heat exchanger as claimed in claim 4, wherein at least one of:
the bead extends at least one of transversely and longitudinally to the first mass flow, and
the elevation extends in a peripheral direction at least partially over the outer surface.

6. The heat exchanger as claimed in claim 4, wherein the inner surface further includes at least one of (i) at least one winglet and (ii) at least one corrugation.

7. The heat exchanger as claimed in claim 1, wherein the at least one tube is a rectangular tube with two narrow outer surfaces and two comparatively wide outer surfaces in relation to the two narrow outer surfaces.

8. The heat exchanger as claimed in claim 1, wherein the plate is connected to the at least one tube via a substance-bonded connection.

9. The heat exchanger as claimed in claim 1, wherein the elevation has a height of between 0.5 mm and 3 mm.

10. The heat exchanger as claimed in claim 1, wherein the following ratio applies:
0.3<a/h<0.7;
wherein
a: is an interval between the plate and the elevation; and
h: is a height of the plate.

11. The heat exchanger as claimed in claim 10, wherein the interval between the plate and the elevation is approx. 20 to 60 mm.

12. The heat exchanger as claimed in claim 1, wherein the at least two flow paths respectively have a porosity factor F ranging between 60% and 90%, wherein the porosity factor F is defined as follows:
F=(A_KM1−A_KM2)/A_KM2;
wherein:
A_KM1: is a surface on a coolant side corresponding to the at least one tube including the elevation, as a partial surface of the total cross-sectional surface;
A_KM2: is a surface on the coolant side corresponding to at least one other tube that is blocked by the elevation; and
(A_KM1−A_KM2): is the remaining open surface through which the first mass flow can continue to flow.

13. An exhaust gas cooler, comprising:
a connection connected to a coolant line for communicating a first mass flow; and
a diffusor connected to an exhaust gas line for communicating a second mass flow;
wherein the connection and the diffusor are arranged in such a manner relative to one another that the first mass flow is introduced substantially at right angles to the second mass flow; and
a heat exchanger for conveying heat between the second mass flow and the first mass flow, wherein the heat exchanger includes:
a fluid-tight housing coupled to the connection for introducing the first mass flow into the housing and coupled to the diffusor for introducing the second mass flow into the housing;
at least one heat-permeable tube extending in the housing and configured to conduct the second mass flow;
wherein the housing and an outer surface of the at least one tube define at least two parallel flow paths for conducting the first mass flow, and wherein the at least two flow paths are delimited on a face end by a plate, the plate at least partially containing the at least one tube; and
wherein the outer surface of the at least one tube includes an elevation configured to distribute the first mass flow substantially uniformly in a region of the plate after entering the housing and divide the first mass flow substantially uniformly among the at least two flow paths.

14. The exhaust gas cooler as claimed in claim 13, wherein the elevation is a stud.

15. The exhaust gas cooler as claimed in claim 13, wherein the at least one tube has an inner surface including a bead disposed opposite of the elevation on the outer surface.

16. The exhaust gas cooler as claimed in claim 15, wherein the bead on the inner surface embosses the elevation on the outer surface of the at least one tube.

17. The exhaust gas cooler as claimed in claim 15, wherein the bead extends at least one of transversely and longitudinally to the first mass flow.

18. The exhaust gas cooler as claimed in claim 15, wherein the elevation extends in a peripheral direction at least partially over the outer surface.

19. The exhaust gas cooler as claimed in claim 15, wherein the inner surface of the at least one tube further includes at least one of a winglet and a corrugation.

20. A heat exchanger for an exhaust gas cooler, comprising:
a housing for conducting a first mass flow;
a plurality of heat-permeable tubes extending in the housing for conducting a second mass flow, the plurality of tubes having an outer surface and an inner surface;
a plurality of parallel flow paths defined between the housing and the outer surface of the plurality of tubes, the plurality of flow paths configured to conducted the first mass flow;
a plate at least partially containing the plurality of tubes and disposed at a face end of the plurality of flow paths;
a connection arranged in a region of the plate and configured to introduce the first mass flow into the housing;
wherein the outer surface of at least one tube of the plurality of tubes includes an elevation configured to distribute the first mass flow substantially uniformly in the region of the plate after entering the housing and divide the first mass flow substantially uniformly among the plurality of flow paths; and
wherein the inner surface of the at least one tube includes a bead disposed opposite of the elevation on the outer surface, wherein the bead on the inner surface embosses the elevation on the outer surface.
